(19) United States
(12) Patent Application Publication
(10) Pub. No.: US 2013/0034231 A1
(43) Pub. Date: Feb. 7, 2013

(54) Spatial audio processing

(71) Applicant: Larry B. Meletio, Dallas, TX (US)

(72) Inventor: Larry B. Meletio, Dallas, TX (US)

(21) Appl. No.: 13/136,608

(22) Filed: Aug. 5, 2011

(51) Int. Cl. H04R 5/00

(52) U.S. Cl. 381/18; 381/17

(57) ABSTRACT

A spatial audio processing uses a matrix of channels and conditioning amplifiers. Four channels are created from two by using a left, right, mono and a differential amp. A timing gate is added and set to the bass frequency to switch the matrix. The matrix starts with channel one receiving the left program. On the next timing cycle, channel two receives the left program, while channel one receives the left rear program. Thereafter, channel three receives the right program and channel four receives the right rear program. This condition continues through the timing order until every channel has received all four programs and then repeats itself. The constant shift in program content eliminates standing waves in any area and opens up the sound in an area that becomes spatial or orbital.

### BACKGROUND OF THE INVENTION

This invention relates generally to the field of audio processing and more particularly to spatial audio processing.

When a sound wave comes in repeated contact with the same structure or surface, standing wave patterns can cancel at least part of the originally transmitted audio signal before the signal is received by the listener. Often, the lower energy frequencies can be canceled out through phase cancellation. The spatial audio processing of the present invention modifies transmission and allows more of the nuances of the program to be heard without changing the acoustical environment. One good example of this phenomenon is in the content of music that is heard through earphones or ear buds. In such an environment, there are no standing waves because of the direct contact from the originating source through the ear canal and eardrum. This is one reason earphones and the like are appealing. Of course, earphones also include some problems.

U.S. Pat. No. 3,697,692 to Hafler and U.S. Pat. No. 4,097,688 to Ochi use a matrix of speaker connections that use full signal and half signal connections, respectively, to bring about a difference in audio presence and create a simulated channel from the division of the left and right channels. With these disclosures, one ends up with 2 primary channels and 2 simulated channels, a combination for a quadraphonic effect. This patent is based on speaker connections.

U.S. Pat. No. 3,766,317 to Sauvey et al. is an automated cross over used in the rear channels of a stereo system to create a change in frequency or contour while listening to the primary left and right channels and changing the rear tones to try to create a simulated four channel effect.

### BRIEF SUMMARY OF THE INVENTION

It is a primary advantage of the present invention to decrease the impact of standing wave patterns that are detrimental to audio reception.

Another advantage of the present invention is to coordinate signal processing to reduce standing waves that would otherwise cancel certain audio signals.

In accordance with a preferred embodiment of the present invention, a method and apparatus for processing stereo audio output signals comprises creating a beat signal, and sequencing audio output between channels based on the beat signal to reduce standing waves. The beat signal is created with a low pass filter.

In accordance with another preferred embodiment of the present invention, there is further created a mono frequency signal based on the stereo audio output signals; creating four output signals consisting of the stereo output signals, the mono frequency signal and the beat signal; and sequencing the four output signals through quad output channels to reduce standing waves.

Other objects and advantages will become apparent from the following descriptions, taken in connection with the accompanying drawings, wherein, by way of illustration and example, an embodiment of the present invention is disclosed.

### BRIEF DESCRIPTION OF THE SEVERAL DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a circuit diagram of an embodiment of the spatial audio processing of the present invention.

FIG. 2 is a circuit diagram of the stereo audio signal initial processing of the preferred embodiment of the spatial audio processing of the present invention.

FIG. 3 is a circuit diagram of the sequencing processing of the preferred embodiment of the spatial audio processing of the present invention.

FIG. 4 is a circuit diagram of the output matrix processing of the preferred embodiment of the spatial audio processing of the present invention.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

The spatial audio processing of the present invention is used with four discrete amplifiers and regular speaker connections that are used in every-day devices such as used in stereos, cars, boats, and theaters for concert sound. The present invention uses only the Left and Right program from a pre amp. It can be a DVD, AM/FM receiver, CD player, MP3, output of a mixing console and home theater, and is independent of how a speaker is wired.

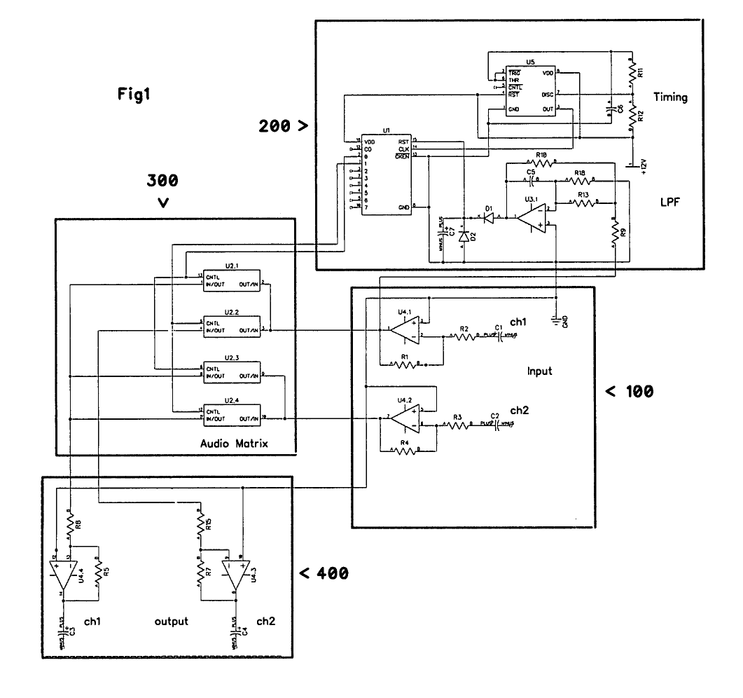

Turning first to FIG. 1, there is shown a circuit diagram for a simple spatial audio processing method and apparatus of the present invention. The input of the circuit, at section 100, is taken from the two standard stereo audio channels, i.e., a left channel and a right channel input, here identified a Ch1ᵢ and Ch2ᵢ where the relationship is not important.

Turning next to section 200, there is shown the components for a low pass filter (LPF) and a timing sequencer. The LPF is a simple circuit to create a beat based on the audio, which is then used to by the sequencer to change the signals being output at section 400. The audio matrix 300, in combination with the sequencer, with input of Ch1ᵢ and Ch2ᵢ, causes a change of output each beat. Accordingly, at one beat from the LPF, Ch1ᵢ input signal is on Ch1ₒ output line, and Ch2ᵢ input signal is on Ch2ₒ output line. At the next audio beat from the LPF, the audio output changes and Ch2ᵢ input signal is on Ch1ₒ output line, and Ch1ᵢ input signal is on Ch2ₒ output line. In this way, any standing waves created by an audio signal repeatedly contacting a stationary object are reduced.

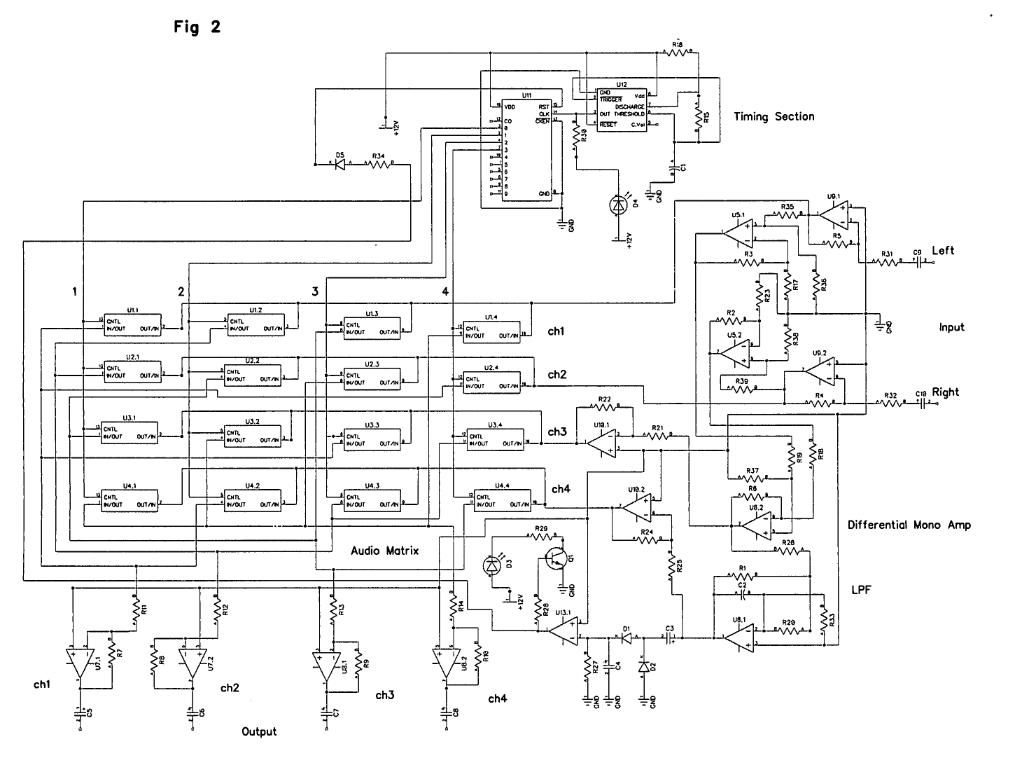

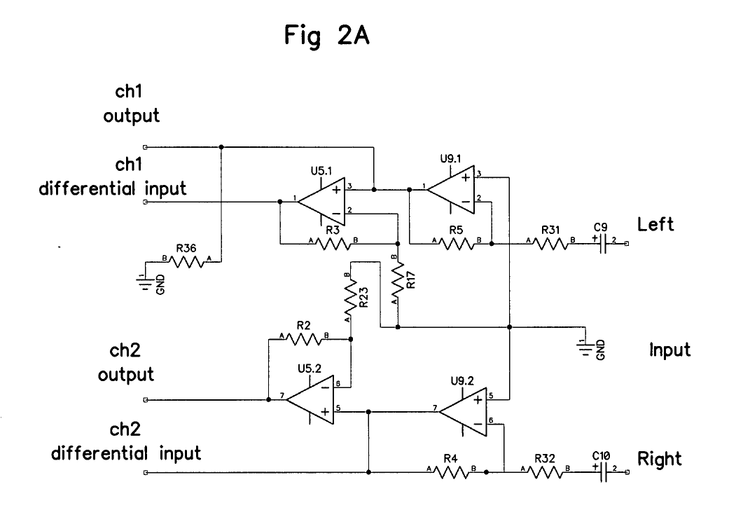

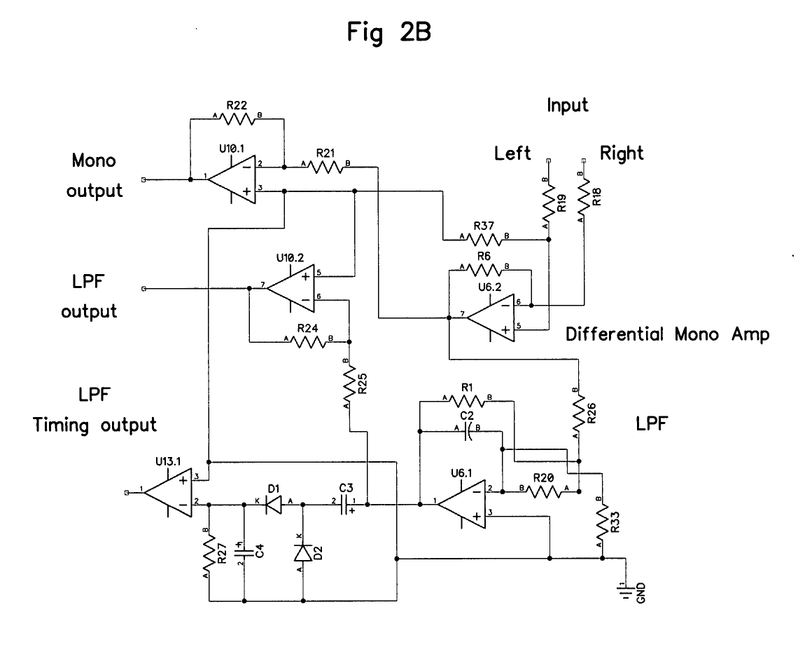

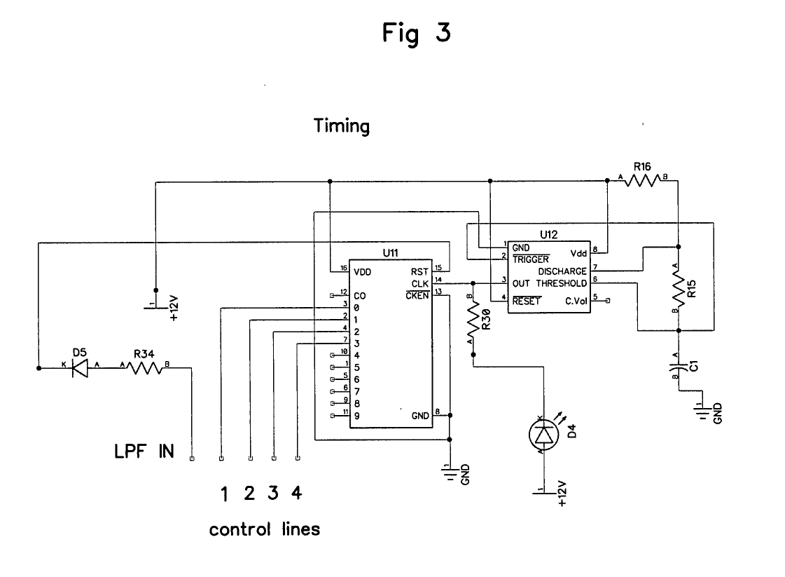

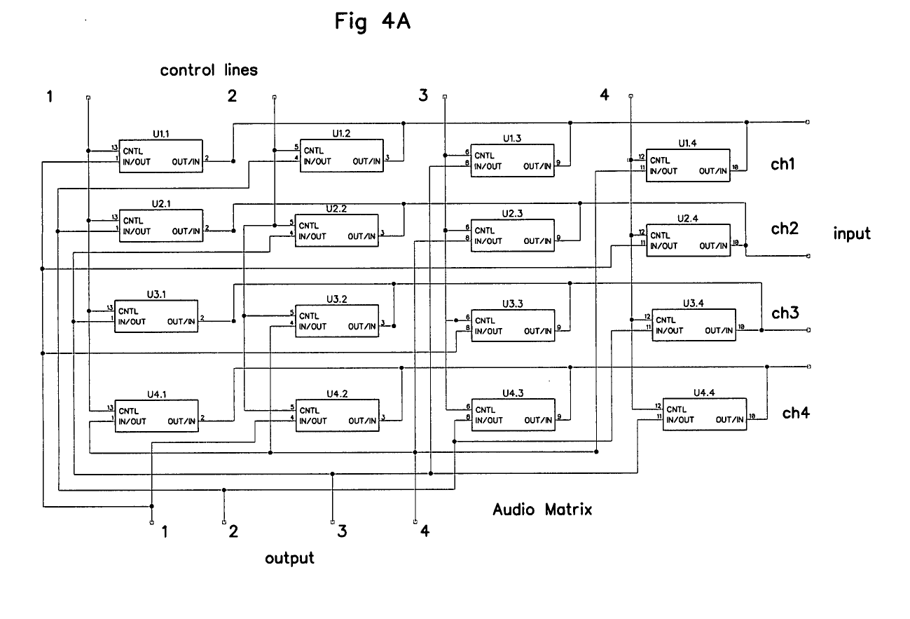

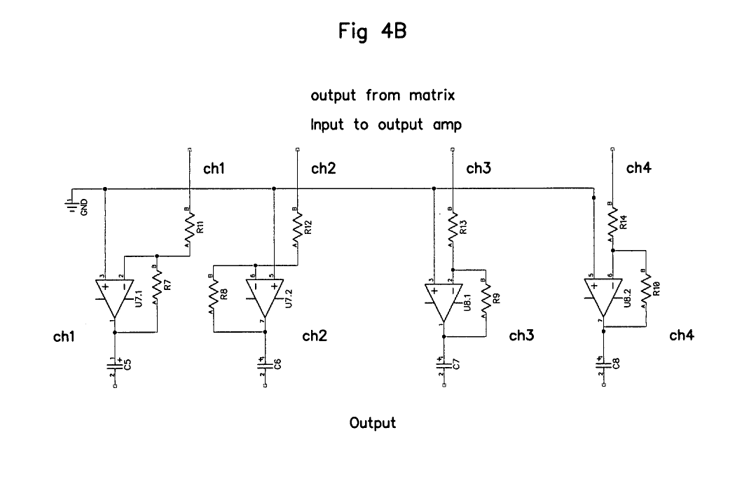

Turning next to FIGS. 2 through 4, there is shown the preferred embodiment of the present invention. Similar to the above description, the spatial audio processing of FIGS. 2 though 4 utilizes the two inputs Ch1ᵢ and Ch2ᵢ. Two additional signals are created based on those inputs: a mono signal and a LPF signal. These four signals are then sequenced though four output audio channels, Ch1ₒ, Ch2ₒ, Ch3ₒ and Ch4ₒ.

There is shown a detailed circuit diagram to carry out the spatial audio processing of the present invention. The spatial audio processing of the present invention is simple and effective through a matrix of channels and conditioning amplifiers. As an initial processing step, four channels are created from two by using a left, right, mono and a differential amp. A timing gate is also added that is set to the bass frequency to switch the matrix. The matrix starts with channel one receiving the left program. On the next timing cycle, channel two receives the left program, while channel one receives the left rear program, then channel three receives the right program and channel four receives the right rear program. This condition continues through the timing order until every channel has received all four programs and then repeats itself. Though the particular sequencing in not important and can be of any sequence, this shift in program content reduces standing waves in an area and opens up the sound in an area that is perceived as spatial or orbital.

The spatial audio processing of the present invention uses the primary left and right channels with a mono and low pass amplifier fed in to a quad matrix, which has the impact of moving the sound in an orbit around the listener, reducing standing waves and uncovering sound that is often canceled through normal listening. This orbit is timed through the low pass filter that moves the sound using the beat or time of the music.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method of processing stereo audio output signals comprising the steps of:
creating a beat signal;
sequencing audio output between output channels based on the beat signal to reduce standing waves.

2. The method of claim 1 wherein the beat signal is created with a low pass filter.

3. The method of claim 1 further comprising the steps of:
creating a mono frequency signal based on the stereo audio output signals;
creating four output signals consisting of the stereo output signals, the mono frequency signal and the beat signal;
sequencing the four output signals through quad output channels to reduce standing waves.

4. An apparatus for processing stereo audio output signals comprising:
creating a beat signal;
sequencing audio output between channels based on the beat signal to reduce standing waves.

5. The apparatus of claim 4 wherein the beat signal is created with a low pass filter.

6. The apparatus of claim 4 further comprising:
creating a mono frequency signal based on the stereo audio output signals;
creating four output signals consisting of the stereo output signals, the mono frequency signal and the beat signal;
sequencing the four output signals through quad output channels to reduce standing waves.
